(19) United States
(12) Patent Application Publication
(10) Pub. No.: US 2002/0101852 A1
(43) Pub. Date: Aug. 1, 2002

(54) POTS/xDSL services line sharing for multiple subscribers

(76) Inventor: Sabit Say, Parsippany, NJ (US)

Correspondence Address: RABIN & CHAMPAGNE, PC, 1101 14TH STREET, NW, SUITE 500, WASHINGTON, DC, 20005, US

(21) Appl. No.: 09/770,662

(22) Filed: Jan. 29, 2001

(51) Int. Cl. H04L 12/66

(52) U.S. Cl. 370/352; 370/493

(57) ABSTRACT

A method and system for providing POTS/xDSL services line sharing for multiple subscribers over the same twisted wire pair is disclosed herein. The lower end of a twisted wire pair's spectrum is used to deliver narrowband services such as POTS to a first subscriber while the higher end of the spectrum is used for high-speed services such as video or data destined to a second subscriber. A POTS splitter remotely located from the central office (CO) separates the POTS signals from the XDSL signals and forwards each signal to its destined subscriber.

### BACKGROUND OF THE INVENTION

The telephone local loop composed of twisted wire pairs and which was originally used to transport analog telephone services, is now being used for high-speed video and data services. High-speed transport over twisted wire pair uses xDSL-based transmission techniques which include Asymmetric Digital Subscriber Line (ADSL), High-bit rate Digital Subscriber Line (HDSL), Rate Adaptive Digital Subscriber Line (RADSL), and Very high speed Digital Subscriber Line (VDSL). These transmission techniques use the upper frequencies of the twisted wire pair's spectrum to deliver services leaving the lower frequencies for Plain Old Telephone Services (POTS) and other narrow-band services.

The companies delivering xDSL-based high-speed services typically lease twisted wire pairs from traditional telephone companies, who are forced to grant access to the telecommunications infrastructure as a result of regulatory changes. As a consequence of the regulatory changes, the twisted wire pair's spectrum is being shared among Incumbent Local Exchange Carrier (ILEC), competitive Local Exchange Carriers (CLEC) and other service providers wherein the ILEC uses the POTS spectrum and the CLEC uses the xDSL spectrum. The variety of services and transmission techniques that are being used over the twisted wire pairs which are generally grouped in binder group creates a compatibility problem between the various xDSL and telephone signals rendering certain twisted wire pairs or portion of their spectrum unusable. This can lead to subscribers being unable to receive certain type of services over the twisted wire pair connection to their residence.

For the foregoing reasons, there is a need for a method and system for providing POTS/xDSL services line sharing for multiple subscribers over the same twisted wire pair

### SUMMARY OF THE INVENTION

The present invention relates to a method and system for providing multiple services to multiple subscribers over the same twisted wire pair, in particular, the present invention provides a method and system for providing POTS/xDSL services line sharing for multiple subscribers.

A method in accordance with one embodiment of the present invention provides xDSL/POTS services line sharing for multiple subscribers. The method comprises the steps of (1) accessing a telephone line supporting POTS services destined to a first subscriber; and (2) multiplexing XDSL services with said POTS services over said telephone line for delivery to a second subscriber. The method may further comprise the steps of splitting the XDSL services from the POTS services at a remote location and forwarding the POTS services to the first services.

In accordance with another embodiment of the present invention, a system for providing POTS/xDSL line sharing for multiple subscribers over a single telephone line is disclosed. The system comprises (1) a POTS interface located at or near the central office for sending to and receiving POTS signals from a first subscriber, (2) a xDSL interface located at or near a central office for sending to and receiving xDSL signals from a second subscriber and (3) a first splitter coupled to said POTS interface and xDSL interface for multiplexing both xDSL and POTS signal over a single telephone line and for splitting xDSL and POTS signals received over said telephone line. The system may further comprise a second splitter located in a remote location for separating POTS signals from xDSL signals and for forwarding said POTS signals to the second subscriber.

These and other features and objects of the invention will be more fully understood from the following detailed description of the preferred embodiments which should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 shows a spectrum mask for POTS/xDSL services

FIG. 2 shows a splitterless configuration for implementing the method of the present invention;

FIG. 3 shows a configuration for implementing the method of the present invention based on the use of an inline splitter on the telephone line;

FIG. 4 shows a configuration for implementing the method of the present invention based on the use of a POTS filter outside of a residence; and

FIG. 5 shows a configuration for implementing the method of the present invention based on the use of an inline splitter on the drop wire.

### DETAILED DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

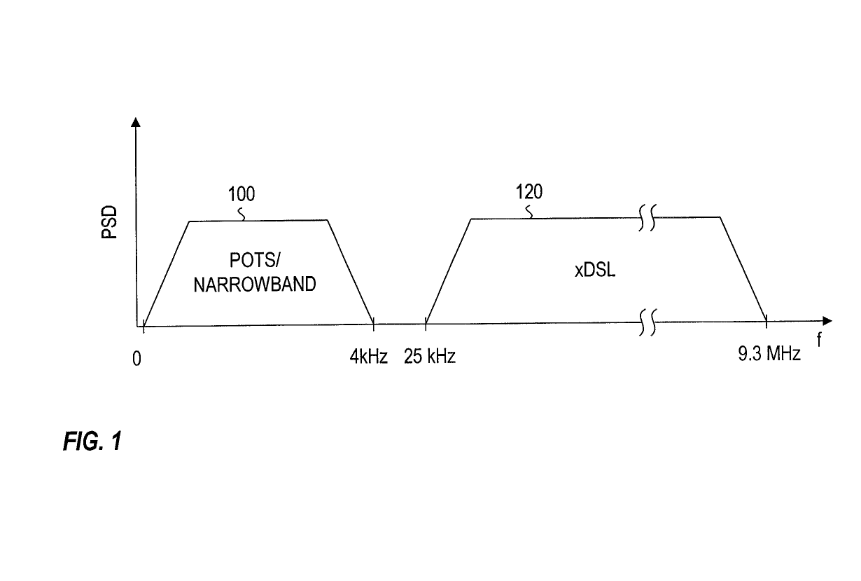

With reference to the drawings, in general, and FIGS. 1 through 5 in particular, the apparatus of the present invention is disclosed.

FIG. 1 shows a spectrum mask for both POTS and DSL services. The POTS spectrum 100 occupies the low frequencies, specifically from 0 to 4 KHz. The POTS spectrum 100 is used to transport voice signals and telephone signaling. The DSL spectrum mask 120 carries xDSL signals including but not limited to Asymmetric Digital Subscriber Line (ADSL), High-bit rate Digital Subscriber Line (HDSL), Rate Adaptive Digital Subscriber Line (RADSL), and Very high speed Digital Subscriber Line (VDSL) signals. The xDSL spectrum mask 120, depending on the specific technology in use (VDSL, ADSL, RADSL or HDSL) can occupy the frequency band from 25.875 KHz up to 9.3 MHz. The spectrum and power spectral density (PSD) mask for each of the xDSL technologies are well known to those skilled in the art.

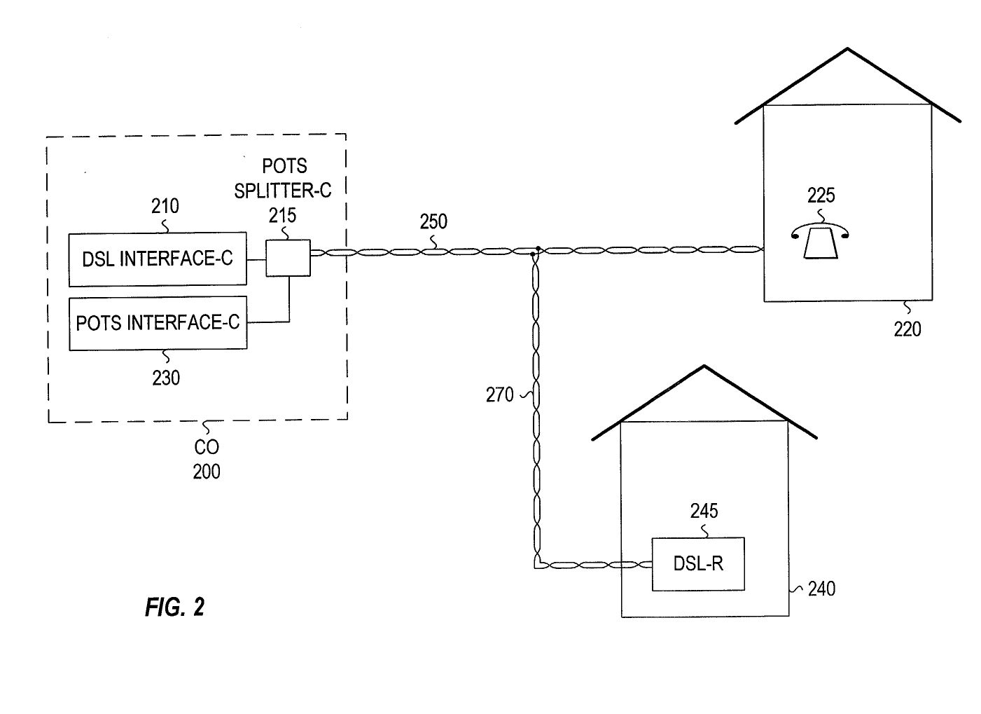

FIG. 2 shows a system for providing POTS/DSL services line sharing for at least two subscribers. In accordance with one embodiment of the present invention, POTS services destined to a first subscriber and DSL services destined to a second subscriber are multiplexed and sent over a single twisted wire pair 250. As illustrated in FIG. 2, at the Central Office (CO) 200, a DSL interface-C 230 and a POTS interface-C are coupled, trough a POTS splitter-C 215, to the twisted wire pair 250. In the present invention, the term DSL interface-C is used in a generic sense and includes software, hardware or combination thereof which may be used to process xDSL signal on reception and to generate xDSL signal for transmission. Such interface may be an xDSL transceiver unit central office site (xTU-C) which complies to the International Telecommunication union (ITU) set of standards for xDSL systems. Similarly, the term POTS interface-C is used to represent the interface between the telephone line and the switch in the CO 200 and may be a subscriber line interface card (SLIC).

The POTS splitter-C 215 performs the multiplexing of telephone signal and xDSL signal and transmits the multiplexed signal over the twisted wire pair 250. In addition, the Pots splitter-C 215 separates POTS signal from xDSL signal when receiving a multiplexed signal from the twisted wire pair 250.

As illustrated in FIG. 2, the twisted wire pair 250 is run from the CO 200 to a first residence 220 when the POTS signal is received by a telephone device 225. A drop wire 270 tapped to the twisted wire pair 250, is connected to a second residence where it is terminated by an xDSL interface-R 245 such as an xTU-R device or xDSL modem. In this embodiment, the DSL interface-R 245 contains a POTS blocking filter which filters out POTS signal and passes the xDSL signal to the other components of the DSL interface-R 245 for processing and for extracting the information.

The need for providing POTS/DSL services line sharing for multiple subscribers may be encountered when a subscriber's telephone line cannot support reliable communication over the xDSL spectrum. In such a situation, a telephone line with unused DSL spectrum in the neighborhood may then be used to carry DSL services for that subscriber.

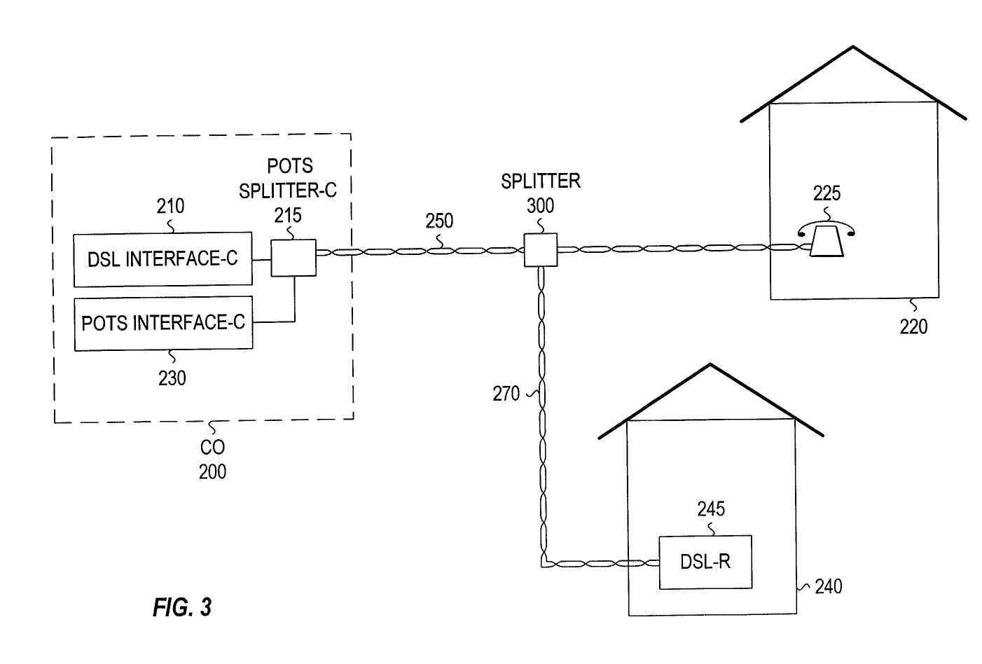

FIG. 3 illustrates an embodiment where an inline POTS splitter-R 300 is used to separate POTS services from DSL services. The inline POTS splitter-R 300 may be mounted in a pedestal or may be placed in the telephone line demarcation point outside of the residence 220. As illustrated in FIG. 3, the POTS splitter 300 is inserted along the twisted wire pair 250 and forwards POTS signals through the twisted wire 250 to the residence 220. The POTS splitter-R 300 also routes the xDSL signal to residence 240 through drop wire 270.

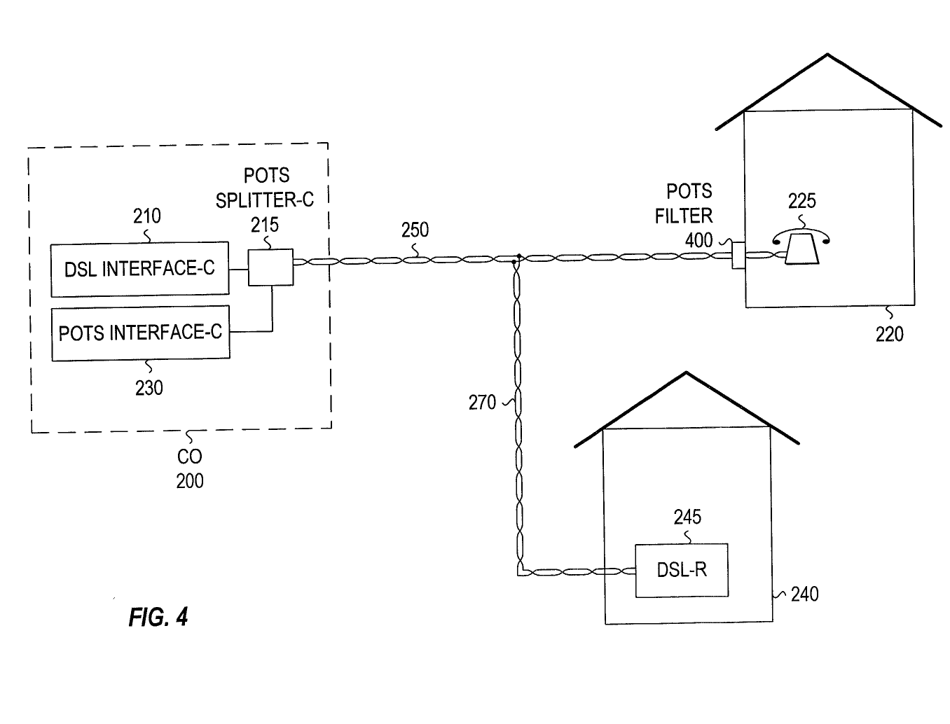

FIG. 4 illustrates an embodiment where a POTS filter 400 is used near the residence 220 to filter out non-POTS signals. In this embodiment, the twisted wire pair 250 is terminated at residence 220 by the POTS filter 400 which passes only POTS signal to the telephone device 225. The POTS filter 400 may be a low pass filter with a frequency cut-off around 4 KHz. The drop wire 270 is tapped to the twisted wire pair 250 and carries both POTS and xDSL signals to the xDSL interface-R 245. In this embodiment, the xDSL interface-R 245 contains a POTS blocking filter which rejects POTS signal. The POTS blocking filter may be a high pass filter or a band-pass filter with a pass band set according to the specific xDSL technology in use.

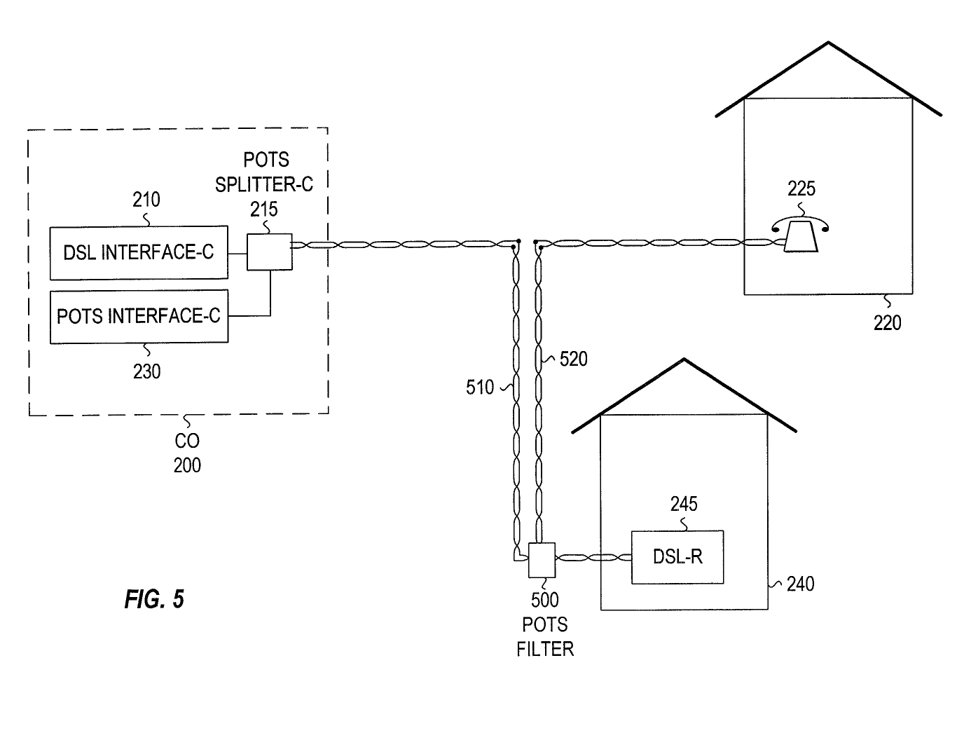

FIG. 5 illustrates an embodiment of the present invention where a POTS filter 500 is placed near the residence 240. In this embodiment a twisted wire pair 510 connects the CO 200 to the residence 240 and a drop wire 520 tapped to twisted wire pair 510 at a location substantially near the residence 240 is run from the tap 530 to the residence 220. An inline POTS filter 500 is inserted along the drop wire 520 to pass the POTS signal. The inline POTS filter 500 may be a low pass filter which rejects the xDSL signal. Similarly, the xDSL interface-R 225 contains a POTS blocking filter which rejects the POTS signal.

Although this invention has been illustrated by reference to specific embodiments, it will be apparent to those skilled in the art that various changes and modifications may be made, which clearly fall within the scope of the invention. The invention is intended to be protected broadly within the spirit and scope of the appended claims.

What is claimed is:

1. A method for providing xDSL/POTS line sharing for multiple subscribers, the method comprising the steps of:
(a) accessing a telephone line supporting POTS services destined to a first subscriber; and
(b) multiplexing xDSL services with said POTS services over said telephone line for delivery to a second subscriber.

2. The method described in claim 1 further comprising the step of:
(c) splitting the xDSL services from the POTS services at a remote location; and
(d) forwarding the POTS services to the first subscriber.

3. The method described in claim 1 further comprising the step of:
(c) splitting the xDSL services from the POTS services at a remote location; and
(d) forwarding the xDSL services to a second subscriber.

4. A system providing POTS/xDSL line sharing for multiple subscribers over a single telephone line, the system comprising:
(a) a xDSL interface located at or near a central office for sending to and receiving xDSL signals from a first subscriber;
(b) a POTS interface located at or near the central office for sending to and receiving POTS signals from a second subscriber; and
(c) a splitter/coupler for multiplexing both xDSL and POTS signal over a single telephone line and for splitting XDSL and POTS signals received over said telephone line.

5. The system described in claim 4 further comprising:
(d) a splitter located in remote location for separating POTS signals from XDSL signals and for forwarding said POTS signals to the second subscriber.
